(19) United States
(12) Patent Application Publication
(10) Pub. No.: US 2026/0242199 A1
(43) Pub. Date: Aug. 20, 2026

(54) METHOD AND SYSTEM FOR CONTROLLING TELESCOPING AMPLITUDE OF AERIAL WORK PLATFORM

(71) Applicant: HUNAN SINOBOOM INTELLIGENT EQUIPMENT CO., LTD., Changsha, Hunan (CN)

(72) Inventors: Junhui ZOU, Changsha, Hunan (CN); Guoliang LIU, Changsha, Hunan (CN); Qing LIU, Changsha, Hunan (CN); Siyi ZOU, Changsha, Hunan (CN); Mingli DONG, Changsha, Hunan (CN); Guirong LIU, Changsha, Hunan (CN)

(73) Assignee: HUNAN SINOBOOM INTELLIGENT EQUIPMENT CO., LTD., Changsha, Hunan (CN)

(21) Appl. No.: 18/879,064

(22) PCT Filed: Oct. 24, 2022
(86) PCT No.: PCT/CN2022/126940

§ 371 Date: Dec. 26, 2024

(30) Foreign Application Priority Data
Aug. 24, 2022 (CN) 202211019072.1

(51) Int. Cl. B66F 17/00

(52) U.S. Cl. CPC B66F 17/006

(57) ABSTRACT

A method and system for controlling a telescoping amplitude of an aerial work platform. The method includes: acquiring a current telescoping travel of a telescopic boom and a travel stage corresponding to the current telescoping travel; determining whether a load of a work basket is greater than a rated load upper limit corresponding to the current travel stage of the telescopic boom; if yes, triggering an overload alarm and locking the telescopic boom; and if not, when the current telescoping travel of the telescopic boom reaches a critical position between the current travel stage and a subsequent travel stage, triggering an over-extension alarm and limiting an outward extension of the telescopic boom. The system can ensure that the telescopic boom can timely and rapidly perform response movements such as retraction.

### CROSS-REFERENCE TO RELATED APPLICATION

This application claims priority to the Chinese patent application No. 202211019072.1, entitled “METHOD AND SYSTEM FOR CONTROLLING TELESCOPING AMPLITUDE OF AERIAL WORK PLATFORM” filed with China National Intellectual Property Administration on Aug. 24, 2022, the entire content of which is incorporated herein by reference.

### TECHNICAL FIELD

The present disclosure relates to the technical field of engineering machinery, and in particular, to a method for controlling a telescoping amplitude of an aerial work platform. The present disclosure further relates to a system for controlling a telescoping amplitude of an aerial work platform.

### BACKGROUND

In recent years, there has been an increasing demand for construction safety and efficiency, leading to a broader application of aerial work platforms. This has led to a greater demand for model diversification of aerial work platforms, while also imposing stricter cost control on the entire vehicle. In order to achieve the aforementioned purpose, an articulating boom model designed for high-reach operations featuring three operating amplitude curves (e.g.: light-load curve of 0~230 kg, medium-load curve of 230~340 kg, and heavy-load curve of 340~454 kg) has been developed.

In order to realize the control of the three amplitude curves, two detectors with different lengths are installed on both sides or the same side of a telescopic boom. In order to ensure a redundant design, two travel switches are used for signal detection on each detector to achieve the detection of three-stage extending range. Based on safety control requirements of an aerial position of a work basket, its control is mainly associated with two alarm detection states, namely an overload alarm and an over-extension alarm.

At present, when the aerial work platform triggers any of the above alarms, the work basket will not be allowed to continue moving in an unsafe direction, and will only be allowed to move in a safe direction to cancel the alarm. However, in the more stringent CE (Conformite Europeenne) standard, if only the overload alarm is triggered, the telescopic boom can be quickly retracted to cancel the alarm. However, when the aerial work platform triggers the overload alarm, it is required to limit all movements of the telescopic boom. This results in a scenario where, as the telescopic boom extends from the heavy-load curve to the light-load curve and reaches the boundary between the two curves, both overload and over-extension alarms are triggered simultaneously. At this point, the boom cannot be retracted to cancel the alarms, rendering the whole vehicle inoperable until a shutdown, inspection, and restart are performed. This impedes the rapid resolution of safety hazards and disrupts continuous production operations.

Therefore, how to timely and rapidly resolve safety hazards and achieve continuous production operations when the telescopic boom extends outwards from the heavy-load curve to the light-load curve is a technical problem faced by those of ordinary skill in the art.

### SUMMARY

An objective of the present disclosure is to provide a method for controlling a telescoping amplitude of an aerial work platform, which can timely and rapidly resolve safety hazards when a telescopic boom extends outwards from a heavy-load curve to a light-load curve and achieve continuous production operations. Another objective of the present disclosure is to provide a system for controlling a telescoping amplitude of an aerial work platform.

In order to address the above technical problems, the present disclosure provides a method for controlling a telescoping amplitude of an aerial work platform, including:
acquiring a current telescoping travel of a telescopic boom and a travel stage corresponding to the current telescoping travel;
determining whether a load of a work basket is greater than a rated load upper limit corresponding to the current travel stage of the telescopic boom;
in response to the load of the work basket being greater than the rated load upper limit corresponding to the current travel stage of the telescopic boom, triggering an overload alarm and locking the telescopic boom; and
in response to the load of the work basket being not greater than the rated load upper limit corresponding to the current travel stage of the telescopic boom, triggering an over-extension alarm and limiting an outward extension of the telescopic boom in case that the current telescoping travel of the telescopic boom reaches a critical position between the current travel stage and a subsequent travel stage.

Preferably, acquiring a current telescoping travel of a telescopic boom includes: detecting a telescoping state of the telescopic boom in real time through a displacement sensor installed on a base boom.

Preferably, the travel stage includes a heavy-load stage, a medium-load stage and a light-load stage, and a telescoping travel of the heavy-load stage is 0~L1, a telescoping travel of the medium-load stage is L1~L2, and a telescoping travel of the light-load stage is L2~Le, where 0<LI<L2<Le, and Le is a limit extending travel.

Preferably, the base boom is provided with a first travel switch at an area corresponding to a critical position between the heavy-load stage and the medium-load stage, and a second travel switch at an area corresponding to a critical position between the medium-load stage and the light-load stage, and the telescopic boom is provided with a first travel detector to trigger the first travel switch in response to the first travel detector moving into position and a second travel detector to trigger the second travel switch in response to the second travel detector moving into position.

Preferably, triggering an over-extension alarm in case that the current telescoping travel of the telescopic boom reaches a critical position between the current travel stage and a subsequent travel stage includes:
in response to the load of the work basket being greater than a rated load upper limit corresponding to the subsequent travel stage, starting a first timer to start timing; and in response to the first travel switch or the second travel switch being triggered, starting a second timer to start timing; and
in response to a timing value of the first timer being greater than a timing value of the second timer, generating an interlocking signal and triggering the over-extension alarm accordingly.

Preferably, after generating the interlocking signal, the method further comprises: assigning a value to the interlocking signal and saving the value.

Preferably, after triggering the over-extension alarm, the method further includes:
retracting the telescopic boom to the current travel stage or any previous travel stage; and cancelling the over-extension alarm.

Preferably, after triggering the over-extension alarm, the method further includes:
keeping the telescopic boom at the current telescopic position and reducing the load of the work basket to be less than a rated load upper limit corresponding to the subsequent travel stage; and cancelling the over-extension alarm.

Preferably, a delay waiting time is reserved before the over-extension alarm is cancelled.

The present disclosure further provides a system for controlling a telescoping amplitude of an aerial work platform, including:
a travel acquisition module configured for acquiring a current telescoping travel of a telescopic boom and a travel stage corresponding to the current telescoping travel;
a first determination module configured for: determining whether a load of a work basket is greater than a rated load upper limit corresponding to the current travel stage of the telescopic boom; and in response to the load of the work basket being greater than the rated load upper limit corresponding to the current travel stage of the telescopic boom, triggering an overload alarm and locking the telescopic boom; and
a second determination module configured for: in response to the load of the work basket being not greater than the rated load upper limit corresponding to the current travel stage of the telescopic boom, determining whether the current telescoping travel of the telescopic boom reaches a critical position between the current travel stage and a subsequent travel stage; and triggering an over-extension alarm and limiting an outward extension of the telescopic boom in case that the current telescoping travel of the telescopic boom reaches a critical position between the current travel stage and a subsequent travel stage.

The method for controlling a telescoping amplitude of an aerial work platform provided by the present disclosure mainly includes two steps. In the first step, the method involves acquiring the current telescoping travel of the telescopic boom and determining the travel stage corresponding to the current telescoping travel when the telescopic boom is at the current telescoping travel position. The travel stage is predetermined based on the entire telescoping travel of the telescopic boom. Generally, there are multiple travel stages. When the telescopic boom starts to extend from a fully retracted state, it will sequentially pass through each travel stage. In the second step, it is first determined whether the load of the work basket is greater than the rated load upper limit corresponding to the current travel stage of the telescopic boom. If so, it indicates that the work basket has been overloaded in the current travel stage, and the overload alarm will be directly triggered, and the telescopic boom will be locked. If not, it indicates that the load of the work basket at this time matches the rated load of the current travel stage, and a worker can operate the telescopic boom to perform normal telescopic movements, thereby continuously extending out the telescopic boom and increasing a working amplitude of the telescopic boom. Then, when the working amplitude of the telescopic boom increases to a certain extent, that is, when the current telescoping travel of the telescopic boom reaches the critical position between the current travel stage and the subsequent travel stage, the telescoping travel of the telescopic boom is about to enter the adjacent subsequent travel stage. At this time, the over-extension alarm will be triggered and the outward extension of the telescopic boom will be limited to prevent the telescopic boom from continuing to extend outwards. This ensures that the working amplitude of the telescopic boom does not become excessive, avoiding a situation where the current load of the work basket exceeds the rated load upper limit in the subsequent travel stage, thereby timely and rapidly resolving the safety hazards. Compared with the existing technologies, the method for controlling a telescoping amplitude of an aerial work platform provided by the present disclosure triggers an overload alarm only in case that the load is greater than the corresponding rated load upper limit during the period when the telescopic boom is within the respective travel stage. At the instant when the telescopic boom enters the adjacent subsequent travel stage with a higher load state, only the over-extension alarm is triggered, while the overload alarm is not triggered. Such process only limits the outward extension of the telescopic boom and does not lock the telescopic boom, thereby ensuring that the telescopic boom can timely and rapidly perform response movements such as retraction. To sum up, the method for controlling a telescoping amplitude of an aerial work platform provided by the present disclosure can timely and rapidly resolve safety hazards when a telescopic boom extends outwards from a heavy-load curve to a light-load curve and achieve continuous production operations.

### BRIEF DESCRIPTION OF DRAWINGS

In order to explain the embodiments of the present disclosure or the technical solutions in the existing technologies more clearly, the accompanying drawings needed to be used in the description of the embodiments or the existing technologies will be briefly introduced below. Obviously, the accompanying drawings in the following description are only embodiments of the present disclosure. For those of ordinary skill in the art, other drawings can be acquired based on the provided drawings without paying creative efforts.

FIG. 1 is a flow chart of a method of a specific implementation provided by the present disclosure.

FIG. 2 is a module diagram of a system of a specific implementation provided by the present disclosure.

FIG. 3 is a schematic diagram of partial structure of an aerial work platform.

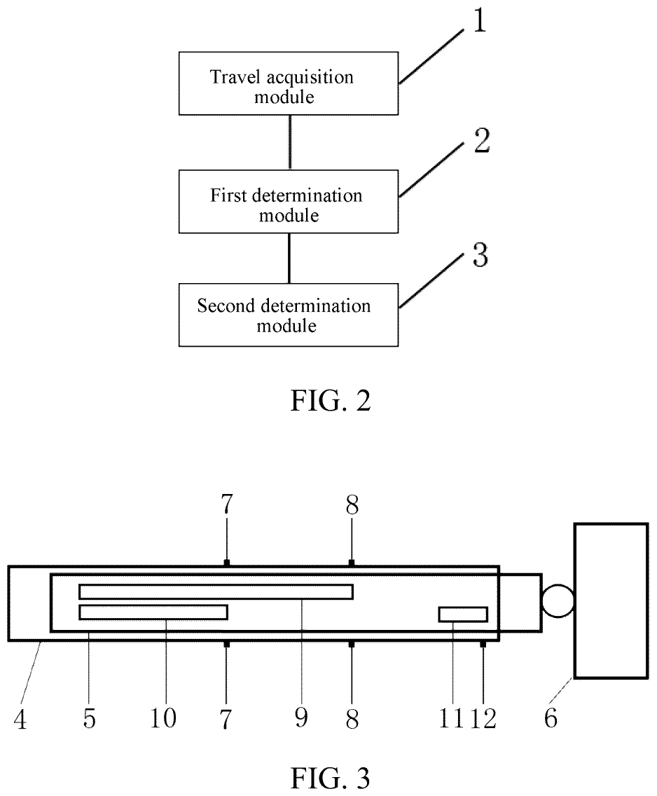

### REFERENCE NUMERALS IN FIG. 2-3:

travel acquisition module 1, first determination module 2, second determination module 3;

base boom 4, telescopic boom 5, work basket 6, first travel switch 7, second travel switch 8, first travel detector 9, second travel detector 10, full retraction detector 11, full retraction travel switch 12.

### DETAILED DESCRIPTION

The technical solutions in the embodiments of the present disclosure will be clearly and completely described below with reference to the accompanying drawings in the embodiments of the present disclosure. Obviously, the described embodiments are only a part of the embodiments of the present disclosure, rather than all the embodiments. Based on the embodiments of the present disclosure, all other embodiments acquired by those of ordinary skill in the art without creative efforts fall within the scope of protection of the present disclosure.

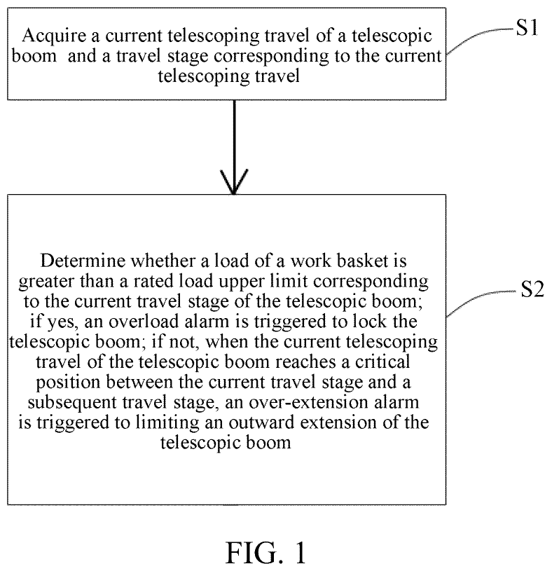

Please refer to FIG. 1, which is a flow chart of a method of a specific implementation provided by the present disclosure.

In a specific implementation provided by the present disclosure, a method for controlling a telescoping amplitude of an aerial work platform mainly includes two steps S1 and S2.

At S1, a current telescoping travel of a telescopic boom 5 and a travel stage corresponding to the current telescoping travel are acquired.

At S2, it is determined whether a load of a work basket 6 is greater than a rated load upper limit corresponding to the current travel stage of the telescopic boom 5; if yes, an overload alarm is triggered to lock the telescopic boom 5; if not, when the current telescoping travel of the telescopic boom 5 reaches a critical position between the current travel stage and a subsequent travel stage, an over-extension alarm is triggered to limiting an outward extension of the telescopic boom 5.

Specifically, at S1, the process involves acquiring the current telescoping travel of the telescopic boom 5 and determining the travel stage corresponding to the current telescoping travel when the telescopic boom 5 is at a position of the current telescoping travel. The travel stage is predetermined based on the entire telescoping travel of the telescopic boom 5. Generally, there are multiple travel stages. When the telescopic boom 5 starts to extend from a fully retracted state, it sequentially pass through each travel stage.

At S2, it is first determined whether the load of the work basket 6 is greater than the rated load upper limit corresponding to the current travel stage of the telescopic boom 5. If yes, it indicates that the work basket 6 has been overloaded in the current travel stage, and the overload alarm will be directly triggered, and the telescopic boom 5 will be locked. If not, it indicates that the load of the work basket 6 at this time matches the rated load of the current travel stage, and a worker can operate the telescopic boom 5 to perform normal telescopic movements, thereby continuously extending the telescopic boom 5 and increasing a working amplitude of the telescopic boom 5.

Then, when the working amplitude of the telescopic boom 5 increases to a certain extent, that is, when the current telescoping travel of the telescopic boom 5 reaches the critical position between the current travel stage and the subsequent travel stage, the telescoping travel of the telescopic boom 5 is about to enter the adjacent subsequent travel stage. At this time, the over-extension alarm will be triggered and the outward extension of the telescopic boom 5 will be limited to prevent the telescopic boom 5 from continuing to extend outwards. This ensures that the working amplitude of the telescopic boom 5 does not become excessive, avoiding a situation where the current load of the work basket 6 exceeds the rated load upper limit in the subsequent travel stage, thereby timely and rapidly resolving the safety hazards.

Compared with the existing technologies, the method for controlling a telescoping amplitude of an aerial work platform provided by the present disclosure triggers an overload alarm only in case that the load is greater than the corresponding rated load upper limit during the period when the telescopic boom 5 is within the respective travel stage. At the instant when the telescopic boom 5 enters the adjacent subsequent travel stage with a higher load state, only the over-extension alarm is triggered, while the overload alarm is not triggered. Such process only limits the outward extension of the telescopic boom 5 and does not lock the telescopic boom 5, thereby ensuring that the telescopic boom 5 can timely and rapidly perform response movements such as retraction.

To sum up, the method for controlling a telescoping amplitude of an aerial work platform provided by the present disclosure can timely and rapidly resolve safety hazards when the telescopic boom 5 extends outwards from a heavy-load curve to a light-load curve, thereby achieving continuous production operations.

In an optional embodiment regarding step S1, in order to conveniently and accurately acquire the current telescoping travel of the telescopic boom 5 in real time, a displacement sensor is installed on a base boom 4 to detect a telescoping state of the telescopic boom 5 in real time through the displacement sensor, including a telescopic direction, a telescopic distance, a telescopic speed and other parameters of the telescopic boom 5.

Meanwhile, after the telescoping travel of the telescopic boom 5 is acquired, in order to conveniently and accurately judge operating safety risks of the telescopic boom 5 under the current load state, this embodiment divides the entire telescoping travel of the telescopic boom 5 in advance. Starting from the telescoping travel of zero (not extended), it is mainly divided into three travel stages, including a heavy-load stage, a medium-load stage and a light-load stage. Among them, a specific telescoping travel of the heavy-load stage is 0~L1, a specific telescoping travel of the medium-load stage is L1~L2, and a specific telescoping travel of the light-load stage is L2~Le, where Le is a limit extending travel of the telescopic boom 5. With this arrangement, when the telescoping travel of the telescopic boom 5 reaches L1, it indicates that the telescopic boom 5 has reached the critical position between the heavy-load stage and the medium-load stage. Similarly, when the telescopic boom 5 reaches L2, it indicates that the telescopic boom 5 has reached the critical position between the medium-load stage and the light-load stage.

Obviously, 0<L1<L2<Le, and the specific values of L1, L2, and Le are not fixed and need to be comprehensively considered based on the model, specifications, load conditions and other factors of the specific aerial work platform. Moreover, the entire telescoping travel of the telescopic boom 5 is not limited to being divided into three stages in the above manner, but can also be divided into more stages more precisely as needed.

As shown in FIG. 3, FIG. 3 is a schematic diagram of partial structure of an aerial work platform. In an optional embodiment regarding step S2, in order to judge accurately and cost-effectively whether the telescoping travel of the telescopic boom 5 reaches the above critical positions, on the one hand, the base boom 4 is provided with a first travel switch 7 at an area corresponding to the critical position between the heavy-load stage and the medium-load stage, and a second travel switch 8 at an area corresponding to the critical position between the medium-load stage and light-load stage; on the other hand, the telescopic boom 5 is provided with a first travel detector 9 and a second travel detector 10.

The first travel detector 9 is mainly used to cooperate with the first travel switch 7, so that when the first travel detector 9 is synchronously displaced to a preset position (at the area corresponding to the critical position between the heavy-load stage and the medium-load stage) with the outward extension of the telescopic boom 5, the first travel switch 7 is triggered, and then the over-extension alarm is triggered through the first travel switch 7.

Similarly, the second travel detector 10 is mainly used to cooperate with the second travel switch 8, so that when the second travel detector 10 is synchronously displaced to a preset position (at the area corresponding to the critical position between the medium-load stage and the light-load stage) with the outward extension of the telescopic boom 5, the second travel switch 8 is triggered, and then the over-extension alarm is triggered through the second travel switch 8.

Continuing from above, in order to trigger the alarm conveniently and accurately through the first travel switch 7 or the second travel switch 8, in this embodiment, two timers are used for timing during the extending process of the telescopic boom 5 in the current travel stage. Specifically, when the load of the work basket 6 is greater than the rated load upper limit corresponding to the subsequent travel stage, the first timer is started for timing, and when the first travel switch 7 or the second travel switch 8 is triggered, the second timer is started for timing. When the telescopic boom 5 moves to the critical position, when a timing value of the first timer is greater than a timing value of the second timer, a rising edge signal is triggered, that is, an interlocking signal is generated. At this time, the system identifies that the telescopic boom 5 performs a cross-stage outward extension at a higher load state, such as extending from the heavy-load stage to the medium-load stage, or extending from the medium-load stage to the light-load stage, and triggers the over-extension alarm accordingly.

Below are some examples for illustrations.

When the telescopic boom 5 is initially in the heavy-load stage, if the current load is greater than the rated load upper limit of the heavy-load stage (e.g. 454 kg), the overload alarm is directly triggered. If the telescopic boom 5 extends outwards with a load in the range of 340~454 kg, the system will make the following judgment: two timers (TON1/TON2, first timer/second timer) are used for timing. TON1 is used for timing when the condition “the current load is greater than the rated load upper limit of the medium-load stage (340 kg)” is met, and TON2 is used for timing when the condition “the first travel switch 7 detects triggering” is met. When the telescopic boom 5 extends to the critical position between the heavy-load stage and the medium-load stage, if the timing value of TON1 is greater than the timing value of TON2, and at the same time the first travel switch 7 detects triggering, the rising edge signal is triggered, and the interlocking signal is assigned a value.

When the telescopic boom 5 is initially in the medium-load stage, if the current load is greater than the rated load upper limit of the medium-load stage (e.g. 340 kg), the overload alarm is directly triggered. If the telescopic boom 5 extends outwards with a load in the range of 230~340 kg, the system will make the following judgment: two timers (TON3/TON4, first timer/second timer) are used for timing. TON3 is used for timing when the condition “the current load is greater than the rated load upper limit of the light-load stage (230 kg)” is met, and TON4 is used for timing when the condition “the second travel switch 8 detects triggering” is met. When the telescopic boom 5 extends to the critical position between the medium-load stage and the light-load stage, if the timing value of TON3 is greater than the timing value of TON4, and at the same time the second travel switch 8 detects triggering, the rising edge signal is triggered, and the interlocking signal is assigned a value. When the telescopic boom 5 is initially in the light-load stage, if the current load is greater than the rated load upper limit of the light-load stage (e.g. 230 kg), the overload alarm is directly triggered. Further, after the interlocking signal is generated, it can also be assigned a value and saved, so that the saved value of the interlocking signal can be read after the system is powered on and restarted to achieve power-off retention of the interlocking signal.

In order to ensure the reliability of control judgment, the timing under the aforementioned load conditions should be carried out after the timing triggered by the travel switch and rising edge judgment to avoid the problem of mistakenly triggering the interlocking signal after the system restarts.

In addition, after triggering of the interlocking signal and over-extension alarm, recovery can be carried out in the following ways.

Specifically, the telescopic boom 5 can be retracted to the current travel stage, or further retracted to the adjacent or any previous travel stage. For example, if the telescopic boom 5 extends outwards to the critical position between the medium-load stage and the light-load stage and the interlocking signal is triggered, an operator can retract the telescopic boom 5 to the medium-load stage, or can further retract the telescopic boom 5 to the heavy-load stage. Then the over-extension alarm can be cancelled.

Of course, if necessary, the telescopic boom 5 can be fully retracted. At this time, whether the telescopic boom 5 is fully retracted can be accurately determined by the cooperation of the full retraction detector 11 disposed on the telescopic boom 5 and the full retraction travel switch 12 disposed on the base boom 4.

Moreover, the telescopic boom 5 can be kept at the current telescopic position, that is, at a certain critical position, and then the load of the work basket 6 is reduced to be less than the rated load upper limit corresponding to the subsequent travel stage. Generally, the load needs to be less than the load capacity corresponding to the subsequent travel stage minus a tolerance value.

Further, when the above operations are performed on the telescopic boom 5 to cancel the over-extension alarm, a certain delay waiting time can also be reserved to avoid the problem caused by abnormal signal drift and repeated recovery of the interlocking signal, that is, only after a certain period of time upon completion of the operations, the over-extension alarm can be cancelled.

As shown in FIG. 2, FIG. 2 is a module diagram of a system of a specific implementation provided by the present disclosure.

This embodiment further provides a system for controlling a telescoping amplitude of an aerial work platform, which mainly includes a travel acquisition module 1, a first determination module 2 and a second determination module 3. Specifically, the travel acquisition module 1 is mainly configured to acquire a current telescoping travel of a telescopic boom 5 and a travel stage corresponding to the current telescoping travel. The first determination module 2 is mainly configured to determine whether a load of a work basket 6 is greater than a rated load upper limit corresponding to the current travel stage of the telescopic boom 5; and if yes, trigger an overload alarm and lock the telescopic boom 5. The second determination module 3 is mainly configured to, when a determination result of the first determination module 2 is no, continue to determine whether the current telescoping travel of the telescopic boom 5 reaches a critical position between the current travel stage and a subsequent travel stage; and if yes, trigger an over-extension alarm and limit an outward extension of the telescopic boom 5.

The above description of the disclosed embodiments enables those of ordinary skill in the art to implement or use the present disclosure. Various modifications to these embodiments will be readily apparent to those of ordinary skill in the art, and the general principles defined herein may be realized in other embodiments without departing from the gist or scope of the present disclosure. Thus, the present disclosure is not intended to be limited to the embodiments shown herein but is to be accorded the widest scope consistent with the principles and novel features disclosed herein.

1. A method for controlling a telescoping amplitude of an aerial work platform, comprising:
acquiring a current telescoping travel of a telescopic boom and a travel stage corresponding to the current telescoping travel;
determining whether a load of a work basket is greater than a rated load upper limit corresponding to the current travel stage of the telescopic boom;
in response to the load of the work basket being greater than the rated load upper limit corresponding to the current travel stage of the telescopic boom, triggering an overload alarm and locking the telescopic boom; and
in response to the load of the work basket being not greater than the rated load upper limit corresponding to the current travel stage of the telescopic boom, triggering an over-extension alarm and limiting an outward extension of the telescopic boom in case that the current telescoping travel of the telescopic boom reaches a critical position between the current travel stage and a subsequent travel stage.

2. The method for controlling a telescoping amplitude of an aerial work platform according to claim 1, wherein acquiring a current telescoping travel of a telescopic boom comprises:
detecting a telescoping state of the telescopic boom in real time through a displacement sensor installed on a base boom.

3. The method for controlling a telescoping amplitude of an aerial work platform according to claim 1, wherein the travel stage comprises a heavy-load stage, a medium-load stage and a light-load stage, and a telescoping travel of the heavy-load stage is 0~L1, a telescoping travel of the medium-load stage is L1~L2, and a telescoping travel of the light-load stage is L2~Le, wherein 0<L1<L2<Le, and Le is a limit extending travel.

4. The method for controlling a telescoping amplitude of an aerial work platform according to claim 3, wherein the base boom is provided with a first travel switch at an area corresponding to a critical position between the heavy-load stage and the medium-load stage, and a second travel switch at an area corresponding to a critical position between the medium-load stage and the light-load stage, and the telescopic boom is provided with a first travel detector to trigger the first travel switch in response to the first travel detector moving into position and a second travel detector to trigger the second travel switch in response to the second travel detector moving into position.

5. The method for controlling a telescoping amplitude of an aerial work platform according to claim 4, wherein triggering an over-extension alarm in case that the current telescoping travel of the telescopic boom reaches a critical position between the current travel stage and a subsequent travel stage comprises:
in response to the load of the work basket being greater than a rated load upper limit corresponding to the subsequent travel stage, starting a first timer to start timing; and in response to the first travel switch or the second travel switch being triggered, starting a second timer to start timing; and
in response to a timing value of the first timer being greater than a timing value of the second timer, generating an interlocking signal and triggering the over-extension alarm accordingly.

6. The method for controlling a telescoping amplitude of an aerial work platform according to claim 5, further comprising: after generating the interlocking signal, assigning a value to the interlocking signal and saving the value.

7. The method for controlling a telescoping amplitude of an aerial work platform according to claim 1, wherein after triggering the over-extension alarm, the method further comprises:
retracting the telescopic boom to the current travel stage or any previous travel stage; and
cancelling the over-extension alarm.

8. The method for controlling a telescoping amplitude of an aerial work platform according to claim 1, wherein after triggering the over-extension alarm, the method further comprises:
keeping the telescopic boom at the current telescopic position and reducing the load of the work basket to be less than a rated load upper limit corresponding to the subsequent travel stage; and
cancelling the over-extension alarm.

9. The method for controlling a telescoping amplitude of an aerial work platform according to claim 7, wherein a delay waiting time is reserved before the over-extension alarm is cancelled.

10. A system for controlling a telescoping amplitude of an aerial work platform, comprising:
a travel acquisition module configured for acquiring a current telescoping travel of a telescopic boom and a travel stage corresponding to the current telescoping travel;
a first determination module configured for: determining whether a load of a work basket is greater than a rated load upper limit corresponding to the current travel stage of the telescopic boom;
and in response to the load of the work basket being greater than the rated load upper limit corresponding to the current travel stage of the telescopic boom, triggering an overload alarm and locking the telescopic boom; and
a second determination module configured for: in response to the load of the work basket being not greater than the rated load upper limit corresponding to the current travel stage of the telescopic boom, determining whether the current telescoping travel of the telescopic boom reaches a critical position between the current travel stage and a subsequent travel stage; and triggering an over-extension alarm and limiting an outward extension of the telescopic boom in case that the current telescoping travel of the telescopic boom reaches a critical position between the current travel stage and a subsequent travel stage.

11. The method for controlling a telescoping amplitude of an aerial work platform according to claim 8, wherein a delay waiting time is reserved before the over-extension alarm is cancelled.
